(19) United States
(12) Patent Application Publication
(10) Pub. No.: US 2026/0108873 A1
(43) Pub. Date: Apr. 23, 2026

(54) PIPETTE TIP AND MOUNTING SHAFT WITH OFFSET LOCKING FEATURE

(71) Applicant: Integra Biosciences AG, Zizers (CH)

(72) Inventors: Terrence Kelly, Lowell, MA (US); Luciano Spiridigliozzi, North Billerica, MA (US); Kyle R. DelloRusso, Derry, NH (US)

(73) Assignee: Integra Biosciences AG, Zizers (CH)

(21) Appl. No.: 19/365,815

(22) Filed: Oct. 22, 2025

Related U.S. Application Data
(60) Provisional application No. 63/710,650, filed on Oct. 23, 2024.

(51) Int. Cl. B01L 3/02; B01L 9/00

(52) U.S. Cl. CPC B01L 3/0275; B01L 9/543; B01L 2200/02

(57) ABSTRACT

Disposable pipette tips are configured with a seal and a locking ring that are offset with respect to the geometry of mounting shaft features to reduce peak insertion force. The mounting shaft has locking lobes, a circumferential stop and a sealing area at or below the stop. The distance between the locking ring in the tip collar and a shoulder separating the collar from the tip barrel is selected to be larger than the distance between the mounting shaft stop and the peak of the locking lobes on the mounting shaft. This causes sequential engagement of the locking features before engagement of the sealing features, and results in lower tip insertion forces..

### CROSS-REFERENCE TO RELATED APPLICATION

The present application claims priority of U.S. Provisional Patent Application No. 63/710,650, filed Oct. 23, 2024, the content of which is incorporated herein by reference in its entirety.

### FIELD OF THE INVENTION

The invention relates to improvements in handheld pipettes and automated liquid handling systems. More specifically, the invention relates to the configuration of disposable pipette tips and mounting shafts and provides robust sealing engagement with low insertion forces while maintaining mounted pipette tips secure and stable on the respective mounting shaft during use.

### BACKGROUND OF THE INVENTION

The use of disposable pipette tips with handheld pipettes and automated liquid handling systems is well known. Disposable pipette tips enable repeated use of pipetting systems to transfer liquid reagents or liquid samples without carryover contamination. Disposable pipette tips are typically formed of a plastic material, such as polypropylene, and have a hollow, elongated, generally conical shape. The upper end of the pipette tip typically includes a collar that is mounted to a mounting shaft on the pipetting device. The mounting shaft is sometimes called the tip fitting. The mounting shaft or tip fitting includes an internal bore through which air is displaced in order to aspirate a liquid sample or reagent into the barrel of the pipette tip and then dispense the liquid sample or reagent from the pipette tip normally in another location. The distal end of the pipette tip has a small opening through which the liquid sample or reagent is received as it is aspirated into the barrel of the pipette tip and then dispensed.

Disposable pipette tips have historically relied on tapered fits between the mounting shaft and the pipette tip collar, as well as sealing rings on the inside circumference of the pipette tip collar, to secure and seal the pipette tips to the mounting shaft. Sometimes an O-ring on the mounting shaft is used to seal against the pipette tip. With tapered fits, the seal between the mounting shaft and the disposable tip is achieved by pushing the tapered mounting shaft into the tapered collar until the mounting shaft wedges into the tip. At this point, a seal is reached between the frustoconical tip collar and the mounting shaft as a result of crushing a sealing ring on the pipette tip (or an O-ring on the mounting shaft) and/or stretching the diameter of the pipette tip.

In addition to achieving a proper seal, it is also important that the position and orientation of the mounted pipette tip be stable in the face of lateral momentum or slight knocking forces that are typical during normal use such as during touch-off against the sidewall of a sample container. To assure tip stability, users tend to jam the mounting shaft into the collar of the tip with excessive force. In handheld pipetting, using excessive force repeatedly to mount and eject pipette tips is not desired for ergonomic reasons. Reducing insertion forces and ejection forces are particularly important in multi-channel, handheld pipettes. It is also desired to minimize insertion and ejection forces in automated or semi-automated liquid handling systems, which often are configured to mount and eject 96 or 384 pipettes tips contemporaneously. Reducing the insertion forces and the ejection forces can reduce the size of the motor drives used in automated liquid handling systems, reduce the system deformation, improve the tip z-position accuracy, and otherwise improve the reliability of such systems. For example, reducing insertion forces enables automated tip racks to be constructed with less plastic and still maintain sufficient structural integrity when mounting the tips. Structural integrity of the automated tip rack is important, e.g., to assure consistent z-position accuracy of all the tips in the array of tips being mounted in an automated or semi-automated liquid handling system.

Various systems have been devised to provide proper sealing and stability without requiring excessive insertion and ejection forces. The assignee of the present application has developed a reliable, ergonomic pipette tip mounting system described generally in U.S. Pat. No. 7,662,343 entitled “Locking Pipette Tip and Mounting Shaft,” issuing on Feb. 16, 2010; U.S. Pat. No. 7,662,344, also issuing on Feb. 12, 2010 and entitled “Locking Pipette Tip and Mounting Shaft;” U.S. Pat. No. 8,277,757 entitled “Pipette Tip Mounting Shaft” and issuing on Oct. 2, 2012; U.S. Pat. No. 8,501,118 entitled “Disposable Pipette Tip” and issuing on Aug. 6, 2013; U.S. Pat. No. 8,877,513 entitled “Method of Using a Disposable Pipette Tip” and issuing on Nov. 4, 2014; and U.S. Pat. No. 9,333,500 entitled “Locking Pipette Tip and Mounting Shaft in a Handheld Manual Pipette” and issuing on May 1, 2016, all incorporated herein by reference. The assignee of the present application has also filed U.S. patent application Ser. No. 18/601,304, U.S. Pub. No. 2024/0307865 A1 entitled “Pipette Tip and Mounting Shaft,” and U.S. patent application Ser. No. 18/601,382, U.S. Pub. No. 2024/0307884 A1, entitled “Pipette Tips and Rack System for Liquid Handling Equipment,” which are also incorporated by reference. In these incorporated patents and patent application owned by the assignee, the tip mounting shaft includes a locking section having circumferentially spaced outwardly extending locking lobes located above a stop which consists of a step spanning between the locking section of the mounting shaft and a lower sealing section of the mounting shaft having a smaller diameter. When the mounting shaft is fully inserted into the collar of a mating disposable pipette tip, the collar of the tip locks onto the mounting shaft. The bore of the pipette tip includes a circumferential shelf or shoulder separating its upper collar from the tip sealing area which is located on the circumferential shelf in more recent designs or below in the barrel of the tip in older designs. The tip collar preferably includes a locking ring at or near the upper opening of the collar through which the mounting shaft is inserted. The dimensions of the collar, and in particular the distance between the circumferential shoulder and the locking ring, are selected to match the dimensions of the mounting shaft between the stop and a catch surface of the upper end of the locking lobes, thus locking the pipette tip in a secure, reliable position and orientation. The locking lobes include an inclining ramp portion that generally flexes and distorts the pipette tip collar out of round as the mounting shaft is inserted into the pipette tip, rather than stretching the tip collar, thereby reducing the amount of insertion force needed to mount the tip. The preferred tip mounting shaft has three lobes spaced equally around the mounting shaft with recessed relief portions spanning between the lobes to accommodate inward distortion of the tip collar between the lobes. As mentioned, the lobes include an inclining ramp that gently slopes between 10-20° with respect to the vertical axis of the mounting shaft. Each lobe extends outward along the ramp towards the top of the locking section of the mounting shaft until it turns inward to form a catch surface. In recent configurations, the lobes have a declining ramp past the peak of the lobe which reduces the required ejection force compared to an abrupt catch surface. When the mounting shaft is fully inserted into the pipette tip, the locking ring on the pipette collar engages the catch surfaces or declining ramps as it is fitted over the peaks of the lobes, thereby providing a secure, snapped-on mount. The amount that the collar is distorted out-of-round is reduced as the locking ring clears the peaks of the lobes to settle on the declining ramps during the insertion process. However, during tip ejection the collar needs to fully distort again for the locking ring to clear the peaks of the lobes on the mounting shaft. The peak of each lobe is preferably slightly rounded to facilitate removal of the pipette tip.

While the collar of the pipette tip is flexed and distorted out-of-round when the lobed mounting shaft is inserted into the pipette tip, the circumferential shoulder on the pipette tip between the collar and the barrel has sufficient structural rigidity to remain round and also isolates the region at the upper end of the barrel from distortion. The structural isolation provided by the circumferential shoulder in the tip facilitates reliable sealing engagement between the lower sealing section of the tip mounting shaft and the sealing region in the upper end of the tip barrel in the incorporated issued patents, or in the case of the pending incorporated applications engagement with a cup seal located at the circumferential shoulder. In some configurations, a sealing ring on the pipette tip extends inward from the upper end of the tip barrel below the circumferential shoulder and engages a sealing region on the mounting shaft below the stop with an interference fit. In other configurations, the mounting shaft includes a groove below the stop that holds an elastomeric O-ring that engages the sealing region at the top of the tip barrel when the mounting shaft is fully inserted into the tip. The O-ring is typically used to reduce the required insertion forces of larger tips that generally require higher insertion forces than smaller tips when a sealing ring on the barrel of the tip is used.

As described in the above incorporated patents and applications owned by assignee, the combination of the locking lobes and the stop on the mounting shaft results in an ergonomic, over-center locking engagement that provides acoustic and tactile feedback to the user of a handheld pipette indicating that the disposable pipette tip is approaching and has been fully engaged on the mounting shaft. As the mounting shaft is pushed into the tip collar, the first point of contact is where the leading edge of the mounting shaft, i.e., the lower sealing section, enters through the circumferential shoulder in the pipette tip and contacts the sealing region in the tip barrel, or in the case of the pending applications contacts the cup seal at the circumferential shoulder. As the mounting shaft is further depressed into the pipette tip bore, the interference for the seal increases and the inclining ramp areas of the locking lobes on the mounting shaft engage the tip collar, and in particular the locking ring around the opening of the tip collar, to distort the upper portion of the collar out-of-round. While the overall insertion force is relatively light and ergonomic compared to other tip fittings, the force increases noticeably and provides tactile feedback to the user that the tip is almost fully mounted. This level of insertion force remains until the stop member on the mounting shaft engages the circumferential shoulder on the pipette tip to abruptly stop further movement of the mounting shaft into the tip. At this point the lobes also snap under the locking ring on the collar, thus providing the user tactile feedback not to use additional, excessive force to mount the tip. These interrelated mounting conditions result in a secure, stable mount with consistent sealing. While automated pipetting systems do not rely on tactile feedback to determine when the tip is properly mounted, the configuration of assignee's pipette tips and mounting shafts provides reliable, robust sealing, with consistent z-axis accuracy and mounting orientation.

While the above tip mounting system described in assignee's incorporated patents and application provides reduced tip insertion forces compared to competitive systems, it is desirable to reduce insertion forces even further. Reducing insertion forces is particularly important in automated systems where 96 or 384 tips are mounted simultaneously. For example, reducing the insertion force means that tip racks for automated systems do not need to be made with as much plastic and support. It is a primary object of the present invention to provide a reduction in the required insertion without substantially affecting the stability of the mounted pipette tips.

### SUMMARY OF THE INVENTION

The inventors have discovered that offsetting the initial engagement of the tip sealing against the mounting shaft from the passing of the lobes on the mounting shaft over the center of the locking ring on the collar of the pipette tip greatly reduces overall peak insertion force. Testing shows that this holds true whether sealing in the upper portion of the barrel as in the incorporated U.S. Pat. Nos. 7,662,343; 7,662,344; 8,277,757; 8,501,118; 8,877,513; and 9,333,500 or sealing with a reverse cup seal at the circumferential shoulder of the tip as in the incorporated '304 and '382 patent applications. Testing has shown that the seal, even with the described offset on initial engagement with the mounting shaft, is robust and reliable, and that the tips also remain aligned and at a consistent z-axis height when mounted. Testing has also shown that despite the reduction in required insertion force, the offset configuration provides clear tactile feedback when the tip is fully mounted and the tip shoulder or the reverse cup seal on the tip shoulder meets the stop on the mounting shaft.

In accordance with the present invention, the vertical distance between the locking ring on the collar of the pipette tip and the circumferential shelf between the collar and the barrel of the tip selected to be farther apart than the distance on the mounting shaft between the peak of the locking lobes and the stop on the mounting shaft. In the prior art tips, these distances were substantially the same so that the engagement of the seal in the tip and the engagement of the locking ring in the tip collar by locking lobes on the mounting shaft occurred simultaneously. By changing the relative distance as described, the engagement of the locking ring on the tip collar over the lobes on the mounting shaft occurs prior to the engagement for sealing the tip against the mounting shaft, which has been found to reduce the peak insertion force. Preferably, the peaks of the lobes on the mounting shaft clear the locking ring prior to the initial engagement of the seal by the mounting shaft. It is also preferred that the locking ring on the collar completely clears the declining ramps on the lobes when the pipette tip is fully mounted. Even though it is preferred that the locking ring no longer presses against the declining ramps of the lobes on the mounting shaft when the tip is fully mounted, it has been found, with automated systems, that the height of the pipette tips on the multi-channel pipetting head remains constant and fixed among all tips in the array.

The amount of force reduction depends on several factors including the size of pipette tip collar, the material of mounting shaft and as well as other factors, but holding other factors constant, it has been found that the reduction of insertion force due to the offset is 30% or more. This reduction of insertion force is useful for both handheld pipettes and for automated systems that mount, e.g., 96 or 384 tips simultaneously. The lower peak insertion forces enable the use of less robust motors to raise and lower the pipetting head in automated or semi-automated systems and enable the use of pipette tip racks that would not be capable of withstanding the high overall insertion forces associated with the simultaneous mounting of arrays of 96 or 384 tips. In turn, it may be possible to use less plastic when manufacturing the plastic components of tip racks.

A first embodiment of the invention applies the engagement offset by modifying the pipette tip configured in accordance with the incorporated '304 and '382 patent applications. The pipette tip is configured to mount on a tip fitting or mounting shaft having circumferentially spaced, outwardly extending locking lobes. Preferably, there are three locking lobes on the mounting shaft. In this first embodiment of the present invention, the pipette tip has a circular cantilevered sealing ring at the circumferential shoulder between the tip collar and the barrel. The circular cantilevered sealing ring has a laterally resilient, annular sealing wall that extends from the circumferential shoulder on the pipette tip towards the collar opening and has an apex that abuts against the stop on the mounting shaft which, as mentioned, provides tactile feedback that the pipette tip is fully mounted. The annular sealing wall of cantilevered sealing ring slants inward slightly as it extends upward from its base. The upper portion of the annular sealing wall is displaced laterally and radially outward when the mounting shaft is inserted and forms a lateral interference seal against the mounting shaft immediately below the stop on the mounting shaft. There is an annular gap between the annular sealing wall and the tip collar. The gap enables the annular sealing wall to move laterally outward without requiring the collar to stretch, which reduces required insertion forces compared to pipette tips that need to stretch the tip to seal. In addition, the sealing region below the stop on the mounting shaft is preferably cylindrical, and the inside diameter immediately below the annular sealing wall of the cantilevered ring seal is preferably chosen to have zero interference with the cylindrical sealing region of the mounting shaft, to help further reduce required insertion forces. The apex of the annular sealing wall abutting against the stop on the mounting shaft provides additional circumferential sealing when the pipette tip is fully mounted.

The presence of the circumferential shoulder of the pipette tip maintains the circular shape at the base of the circular cantilevered sealing ring even when the collar is otherwise being distorted out-of-round to lock over the lobes on the mounting shaft. Similar to assignees prior pipettes, each of the locking lobes on the pipette tip mounting shaft includes an inclining ramp portion that angles outward as the inclining ramp extends upward along the mounting shaft. The purpose of the inclining ramp portion of the lobes is to facilitate distortion of the pipette tip collar out-of-round as the mounting shaft is inserted into the pipette tip. Relief portions spanning between the outwardly extending lobes and recessed with respect to the lobes accommodate inward distortion of the pipette tip collar between the lobes as in the prior art. Accordingly, when a pipette tip is being mounted to a mounting shaft in accordance with the invention, the collar of the pipette tip is distorted out-of-round but the circumferential shoulder of the pipette tip between the collar and the barrel remains substantially circular and undistorted. The structural integrity of the circumferential shoulder on the tip in turn maintains the circular and undistorted shape of the base of the circular cantilever sealing ring.

It is preferred that the pipette tips have a lower stabilizing ring on the inside surface of the tip barrel below the circumferential shelf between the collar and the barrel. The lower stabilizing ring does not seal against the mounting shaft but engages the mounting shaft below the stop on the mounting shaft to stabilize the attachment and alignment of the pipette tip on the mounting shaft. It is also preferred that the locking ring on the collar serves as an upper stabilization ring when the tip is fully mounted. Desirably, the diameter of the mounting shaft above the declining ramps of the locking lobes is selected to match the inside diameter of the locking (and upper stabilizing) ring in its relaxed state, or slightly larger (e.g., 1-2 mil) if a higher level of stabilization is desired. By stabilizing with the locking (and upper stabilizing) ring in the collar and a lower stabilizing ring in the barrel, lateral loads on the seal are minimized or eliminated, which improves seal performance under normal working conditions. Testing has shown pipette tips construction in accordance with the first embodiment of the invention to be reliably stable and aligned when upper and lower stabilization rings are provided. For smaller sized pipette tips, it has been found preferrable to match the diameters of the upper and lower stabilizing rings with the diameter of the mounting shaft at the respective locations. For longer pipette tips, it may be desirable to provide a slight interference fit particularly with the upper stabilizing ring and the mounting shaft. The cross section of the mounting shaft immediately above the lobes is generally triangular (see FIG. 3, reference number 12) with rounded corners. If slight interference is employed, the collar distortion will remain distorted lightly when the tip is fully mounted, however the structural integrity of the circumferential shoulder on the tip isolates the circular and undistorted shape of the base of the circular cantilever sealing ring on the tip.

For larger tips, as mentioned, it may be desirable to use an O-ring in the sealing region of the mounting shaft to further reduce insertion forces. However, it is contemplated that O-rings will not be necessary even with larger tips in part because the configuration of the circular cantilevered sealing ring reduces insertion forces significantly compared to previous sealing methods, and also because the offset engagement further reduces peak insertion force.

A second disclosed embodiment of the invention applies the engagement offset to the mounting of a pipette tip configured to seal in the upper portion of the barrel as in the incorporated U.S. Pat. Nos. 7,662,343; 7,662,344; 8,277,757; 8,501,118; 8,877,513; and 9,333,500. Testing shows that offsetting the engagement of the seal in the tip barrel from the engagement of the locking ring on the tip collar with the mounting shaft lobes reduces overall peak insertion force in this second embodiment as well.

In both the first and second embodiments ot he invention, it is preferred that each of the locking lobes includes a peak portion that is located at a maximum outward distance from the longitudinal axis of the mounting shaft as well as a declining ramp portion that angles inward towards the longitudinal axis on the mounting shaft as it extends upward away from the peak of the lobe along the mounting shaft. However, the invention can be implemented with a mounting shaft having more abrupt catch surfaces on the locking lobes than a gently declining ramp. The mounting shaft has three or more locking lobes and preferably three locking lobes. It is preferred that the lobes comprise less than 15% of the circumference of the mounting shaft at the peak portion of the lobes with the remaining portion of the circumference of the mounting shaft being consumed by relief portions between the lobes. This configuration with relatively thin locking lobes helps to reduce friction between the tip collar and the mounting shaft and reduces insertion and ejection forces, while at the same time provides stable over-center mounting of the tip over the lobes.

These and other aspects, features and advantages of the invention are now described in greater detail with reference to the accompanying drawings.

### BRIEF DESCRIPTION OF THE DRAWINGS

FIG. 1 is a manually assisted 384-well robotic pipetting instrument using mounting shafts and pipette tips configured to offset engagement of the locking ring over mounting shaft lobes and the sealing of the tip against the mounting shaft, in accordance with the present invention.

FIG. 2 is a perspective view showing a disposable pipette tip and tip mounting shaft constructed in accordance with a first embodiment of the invention.

FIG. 3 is a side elevational view of the mounting shaft and pipette tip shown in FIG. 2.

FIG. 4 is a longitudinal cross-section taken along line 4-4 in FIG. 3.

FIG. 5 is a detailed view of an area encircled by line 5-5 in FIG. 4 showing an upper locking collar, a circumferential shoulder and a circular cantilevered sealing ring on the disposable pipette tip illustrated in FIGS. 2 and 4.

FIG. 6 is a detailed view of the area encircled by line 6-6 in FIG. 4 showing a locking section, a cylindrical sealing section and a stop of the tip mounting shaft shown in FIGS. 2 and 4.

FIG. 7 is a side elevational view showing the mounting shaft being inserted into the disposable pipette tip.

FIG. 8 is a longitudinal cross-sectional view taken along line 8-8 in FIG. 7.

FIG. 9 A is a drawing showing the mounting shaft and pipette tip configured in accordance with the first embodiment of the invention with the mounting shaft being inserted into the pipette tip and the inclining ramps of the locking lobes on the mounting shaft beginning to contact the locking ring on the inside surface of the tip collar.

FIG. 9B is a view similar to FIG. 9A in which the mounting shaft has been inserted deeper into the pipette tip such that the peaks of the lobes on the mounting shaft are passing over the locking ring on the tip collar but the mounting shaft has not yet engaged the cantilevered circular seal on the tip.

FIG. 9C is a view similar to FIGS. 9A-9B in which the mounting shaft has been inserted deeper into the pipette tip such that the peak of the lobes on the mounting shaft have passed over the locking ring on the tip collar and the mounting shaft has still not engaged the cantilevered circular seal on the tip.

FIG. 9D is a view similar to FIGS. 9A-9C in which the mounting shaft has been inserted deeper into the pipette tip the FIG. 9C such that the mounting shaft begins to engage with the cantilevered circular seal on the pipette tip.

FIG. 9E is a view similar to FIGS. 9A-9D in which the mounting shaft has been fully inserted into the pipette tip such that the apex of the cantilevered circular seal on the pipette tip engages the stop on the mounting shaft, and the locking ring on the pipette tip has fully cleared the lobes on the mounting shaft.

FIG. 10 is a plot comparing the force profile of the mounting shaft and tip configuration illustrated in FIGS. 9A-9E implementing sequential engagement in accordance with the invention to an otherwise similarly configured mounting shaft and tip with simultaneous engagement.

FIG. 10A is a plot like FIG. 10 showing an additional force profile in which the pipette tip is configured with the locking ring and circumferential shelf closer together than in FIGS. 9A-9E and 10, but still implementing offset engagement in accordance with the invention.

FIG. 11A is a plot illustrating insertion force versus insertion depth with the mounting shaft and pipette tip configured for simultaneous engagement.

FIG. 11B is a plot illustrating insertion force versus insertion depth with the mounting shaft and pipette tip configured for fully sequentially engagement.

FIG. 12 is a perspective view of pipette tip rack system containing disposable pipette tips configured in accordance with the invention.

FIG. 13. is an assembly view of the pipette tip rack system shown in FIG. 12.

### DETAILED DESCRIPTION

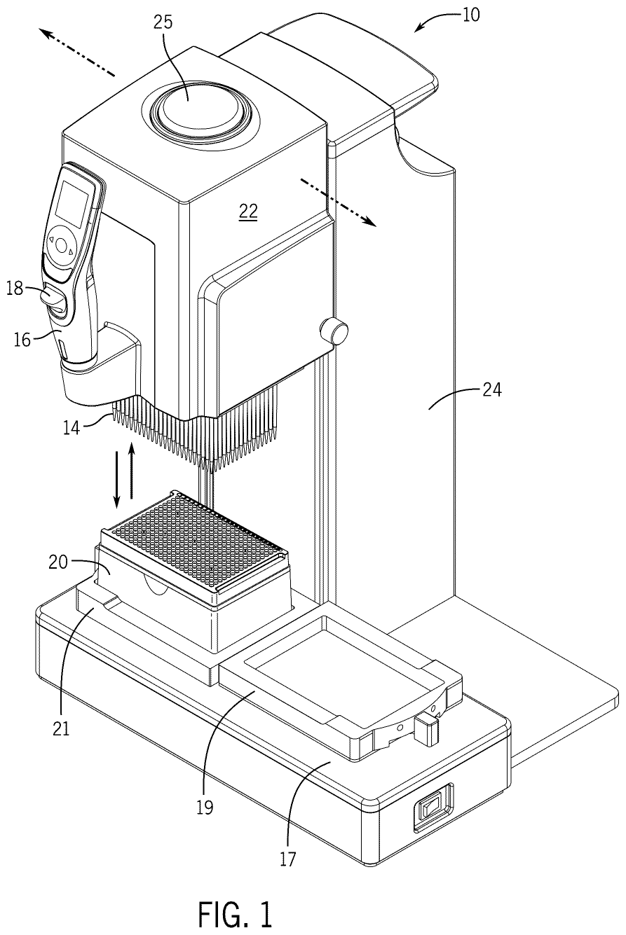

FIG. 1 illustrates a manually directed, 384-channel robotic pipetting system 10, as an exemplary semi-automated liquid handling system in connection with the invention can be implemented. Specifics of how the robotic pipetting system 10 operates are disclosed in U.S. Pat. No. 8,367,022, entitled “Unintended Motion Control for Manually Directed Multi-Channel Electronic Pipettor,” by Warhurst et al., issuing on Feb. 5, 2013 and incorporated herein by reference; and U.S. Pat. No. 8,372,356, entitled “Manually Directed, Multi-Channel Electronic Pipetting System,” by Warhurst et al., issuing on Feb. 12, 2013 and also incorporated herein by reference. Briefly, the robotic pipetting system 10 is shown with an array of 384 disposable pipette tips 14 mounted onto an array (16×24) of mounting shafts 12 on a pipetting head attached to the system 10. The tip mounting shafts 12 and the disposable pipette tips 14 are constructed as discussed below. When mounting an array of pipette tips 14 simultaneously onto an array of mounting shafts 12, the required cumulative insertion force is significantly greater than with a single channel, handheld pipette or even an 8-, 12- or 16-channel handheld pipette. In fact, the cumulative insertion force to attach 384 tips simultaneously is significantly more than 96 tips. The robotic pipetting system 10 in FIG. 1 has a vertical drive mechanism that is used to raise and lower the pipetting head and generate enough force for simultaneous insertion into 96 or 384 tips. It is known in robotic pipetting systems, whether manually directed like the system 10 in FIG. 1, or fully automated like many other laboratory liquid handling systems, to have a vertical drive mechanism to raise and lower the pipetting head with enough force to simultaneously mount 96 or 384 pipette tips.

The robotic pipetting system 10 in FIG. 1 has a flat deck 17 supporting a right-side nesting receptacle 19 and a left-side nesting receptacle 21. The nesting receptacles 19, 21 are designed to hold microtiter plates, reagent reservoirs, or pipette tip racks in known locations on the deck 17. The nesting receptacles 19, 21 desirably have dimensions defined by SBS standards as is known in the art. FIG. 1 shows a pipette tip rack system 20 in the left-side nesting receptacle 21. The pipette tip rack 20 holds 384 pipette tips which in FIG. 1 have been mounted to a pipetting head attached to the carriage 22 of the robotic pipetting system 10. The carriage 22 in turn is mounted to a tower 24. In some systems, the pipetting head is replaceable, which would enable the customer to switch between 384 and 96 channel heads if desired, or to change the size and configuration of the mounting shafts to accommodate different pipette tips. A pipetting motor located within the carriage 22 drives the multi-channel pipetting head to aspirate and dispense. A Z-axis vertical drive mechanism moves the carriage 22 and the multi-channel pipetting head vertically with respect to the tower 24 and the deck 17. An X-axis drive mechanism moves the tower 24 and the carriage 22 horizontally along an X-axis so that the pipetting head and the array of tips 14 can be moved over the right-side nesting receptacle 17 on the deck 16 or over the left-side nesting receptacle 21 on the deck 17.

The system 10 includes a control handle 16 mounted to the carriage 22 and resembling a handle for a handheld electronic pipette. In use, the user grasps the control handle 16 in a manner similar as when using a handheld pipette and exerts pressure on the control handle 16 to move the carriage 22 and the pipetting head. The vertical Z-axis motion and the horizontal X-axis motion are driven by independent motors under servo control. The control handle 16 in system 10 also includes a user interface for controlling pipetting functions such as aspirating and dispensing.

To mount the pipette tips, the pipetting head with the array of tip mounting shafts is aligned precisely over the tip rack 20 located on deck 17 using the X-axis horizontal drive mechanism, with the assistance of software guidance. Then, the Z-axis vertical drive mechanism is used to lower the carriage 22 and the tip mounting shafts 12 with sufficient force to attach the array of pipette tips 14 held in the pipette tip rack 20. The carriage 22 and the pipetting head are then raised using the Z-axis vertical drive mechanism to remove the tips 14 from the tip rack 20. The tip rack 20 is removed from the nesting receptacle 21 on the deck 16 and replaced with a well plate or reservoir in order to transfer fluids.

For tip attachment as with regular motion control, the general horizontal and vertical motion of the carriage 22 and pipetting head is controlled by the user by holding the controller 16 in their palm and applying pressure in the appropriate direction to position the pipetting head over the rack 20 of pipette tips 14. Biasing motion control software can be used to achieve precise alignment necessary for tip attachment. Once the pipetting head and the tip mounting shafts 12 are aligned, the handle control 16 is disabled and an automated tip attachment routine is used to provide sufficient downward force to attach the tips 14 to the mounting shafts 12. As a safety precaution, the automated tip attachment routine can be activated only when one of the user's hands depresses the button 25 on the top of the carriage 22 and the other hand is detected to be present on the handle 16.

Once the tips 14 are mounted, internal components in the carriage drive 22 pistons that each extend through a seal assembly to displace air within an aspiration and dispensing cylinder. The tip mounting shafts 12 are attached to the pipetting head such that each shaft is in fluid communication with one of the aspiration and dispensing chambers. The user interface on the handle 16 includes thumb wheel control, run button and a display. The handle 16 also includes a lever or ejection button 18 that is pushed downward to activate downward movement of an ejection plate on the pipette head. The ejection plate is desirably stepped so that the tips are ejected in stages thereby reducing the required ejection force.

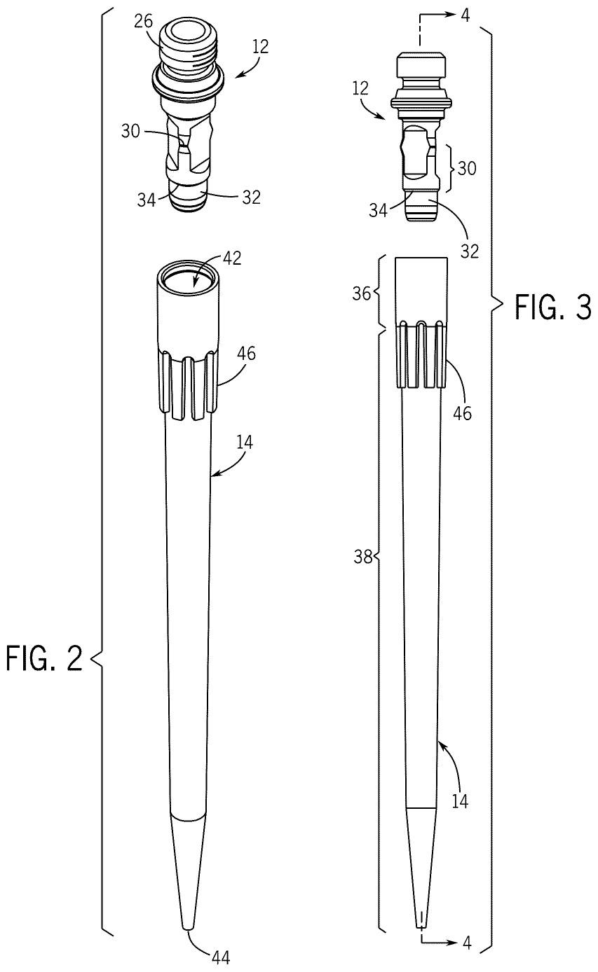

The invention pertains to reducing the peak insertion force, which is useful in automated systems since the cumulative insertion force of 384 or even 96 pipette tips can be significant but reducing insertion force is also useful for handheld pipettes for ergonomic reasons. The mounting shaft 12 and pipette tip 14 illustrated in FIGS. 2 through 8 provide low insertion forces, and robust reliable sealing in accordance with a first embodiment of the present invention. The invention in this first embodiment pertains to modifications made to the relative dimensions of the pipette tip and the mounting shaft described in the incorporated, co-pending '304 and '382 applications.

As shown in FIG. 2, the mounting shaft 12 has threads 26 for attaching it to the lower end of the aspiration and dispensing cylinder (not shown) on the pipetting head of the robotic liquid handling system 10, or a handheld pipette. In FIGS. 2 through 8, as in the incorporated, co-pending '304 and '382 applications, the dimensions of the mounting shaft 12 correspond to the dimensions of the pipette tip 14 so that only pipette tips 14 with the proper dimensions fit onto the respective mounting shaft 12 and engage properly. For example, even if the pipette tips are constructed in accordance with the invention, if one chooses to use pipette tips with a different bore dimension in the collar or sealing region, it is necessary to replace the pipetting head with a new pipetting head with mounting shafts 12 having appropriate dimensions for the tips 14 being mounted and used.

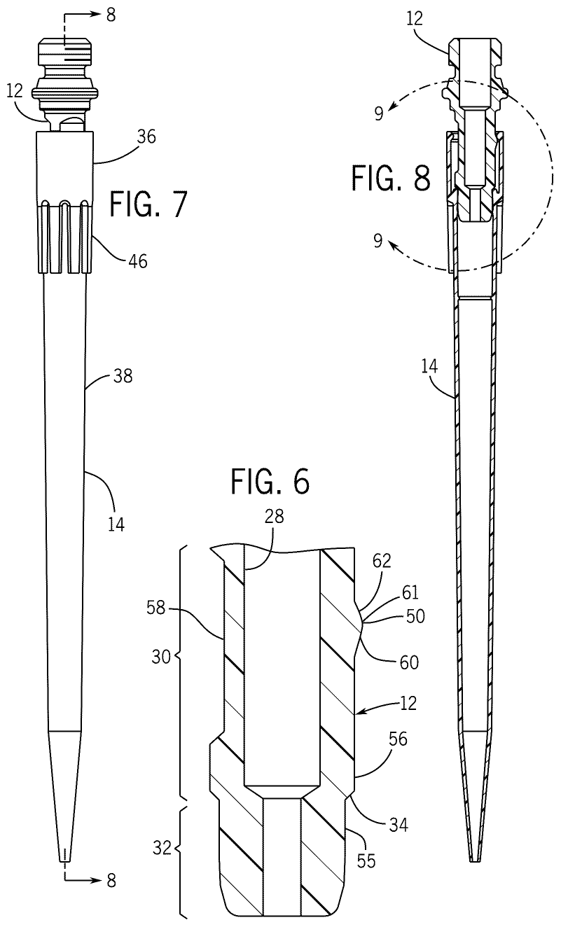

Referring now in general to FIGS. 2-6, the mounting shaft 12 contains a central bore 28 (FIG. 6) for air to pass between the aspiration and dispensing cylinder in the pipette 10 and the pipette tip 14, as is well known in the art. The pipette mounting shaft 12 includes an upper locking section 30, a lower section 32, and a stop 34 located between the upper locking section 30 and the lower section 32. Sealing occurs in the area 55 (see FIG. 6) of the lower section 32 on the mounting shaft 12 immediately below the stop 34 (see FIG. 6) and against the downward facing surface of the stop 34. The locking section 30 of the mounting shaft 12 has outwardly extending locking lobes 50 and recessed areas 58 (see e.g., FIG. 6) spanning between the locking lobes 50. As illustrated in FIG. 6, the recessed area 58 extends above the lobes 50 such that the mounting shaft 12 has a generally triangular cross section with round corners above the lobes 50. In the prior art, the radius of the mounting shaft 12 at the round corners of triangular cross section was less than half the inside diameter of the locking ring 48 on the tip collar 14. In the preferred embodiments of the invention, the radius of the mounting shaft 12 at the round corners of triangular cross section is extended to match the inside diameter of the locking ring 14, or extended slightly more (e.g. 1 to 2 mil interference fit).

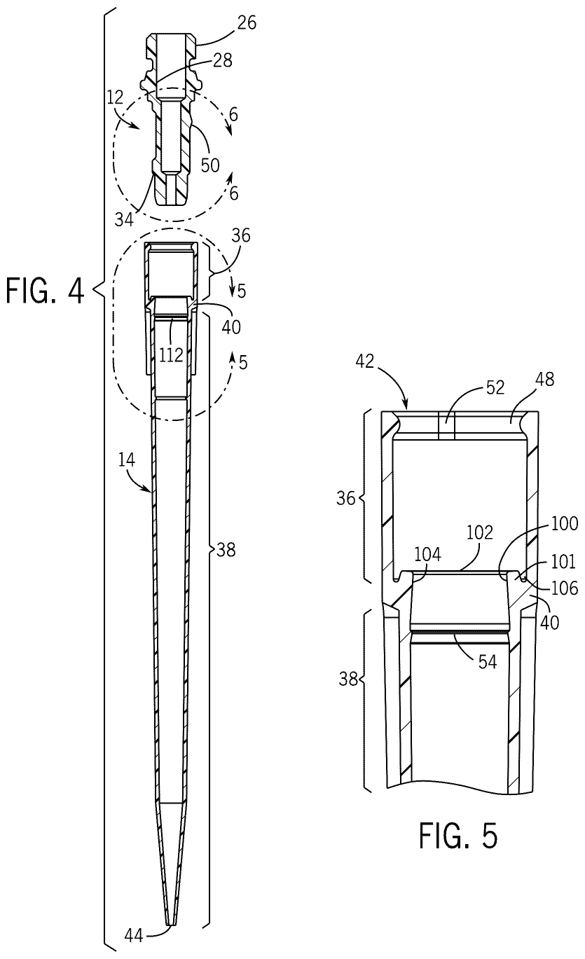

The pipette tip 14 generally consists of a collar 36, a barrel 38 and circumferential shoulder 40 (see e.g., FIGS. 4 and 5) that extends around the inside bore of the tip 14 and connects the lower end of the collar 36 to the upper end of the barrel 38. The upper end of collar 36 has an opening 42 to receive the pipette mounting shaft 12. The lower end of the barrel 38 has a small opening 44 through which liquid is aspirated into the tip barrel 38 and dispensed from the tip barrel 38 during normal operation of the pipette 10. Support ribs 46 (FIG. 3) extend downward on the outside surface of the disposable pipette tip 14 from the collar 36. The support ribs 46 function to hold the tip 14 or an array of tips 14 in a rack for subsequent use and mounting, as is known in the art.

Referring to FIG. 5, a circumferential locking ring 48 is located on the inside surface of the collar 36 of the pipette tip 14. The locking ring 48 is located at or slightly below the opening 42 in the collar 36 through which the mounting shaft 12 is inserted. The locking ring 48 extends inward from the inside wall of the collar 36 a slight amount, preferably in the range of 0.025 to 0.25 mm, in order to provide an over-center locking fit over the peak 61 of the lobes 50 on the mounting shaft 12 (see FIG. 6). The locking ring 48 can contain an optional air bleed 52 although such an air bleed is not necessary in most circumstances because the distortion of the collar 36 when the tip is mounted should normally provide sufficient clearance over the recessed areas 58 of the mounting shaft 12. The inside surface of the collar 36 is preferably slightly tapered or slightly frustoconical but can also be cylindrical. The preferred taper is between 0° and 10°. In any event, horizontal cross-sections through the main section of the collar 36 are circular.

As mentioned, the circumferential shoulder 40 on the tip 14 connects the lower end of the collar 36 to the upper end of the barrel 38. A circular cantilever sealing ring 100 includes a resilient annular wall 101 that extends from the tip shoulder 40 towards the collar opening 42. The purpose of the laterally resilient annular wall 101 is to laterally engage and seal against the cylindrical sealing area 55 (see FIG. 6) on the mounting shaft 12 when the tip 14 is fully mounted to the mounting shaft 12. The annular wall 100 has an upper free end 102 that abuts the stop 34 on the pipette mounting shaft 12 when the tip 14 is fully mounted to the mounting shaft 12. This lateral seal is sometimes referred to as a reverse cup seal.

The collar 36 of the disposable pipette tip 14 is sufficiently flexible to distort outwardly at the lobes 50 on the mounting shaft 12 and inwardly at the recessed relief portions 58 on the mounting shaft between the lobes when the pipette tip 14 is mounted on the tip mounting shaft 12. However, the circumferential shoulder 40 has sufficient structural integrity to maintain roundness of the circular cantilever sealing ring 100 so that an inside surface 104 of the annular wall 101 seals laterally against the sealing area 55 of the mounting shaft 12.

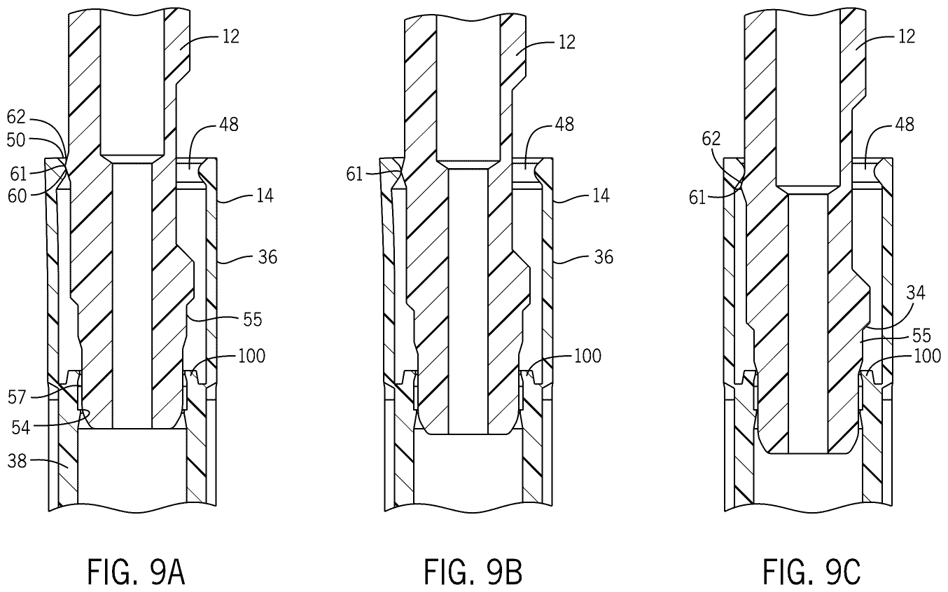

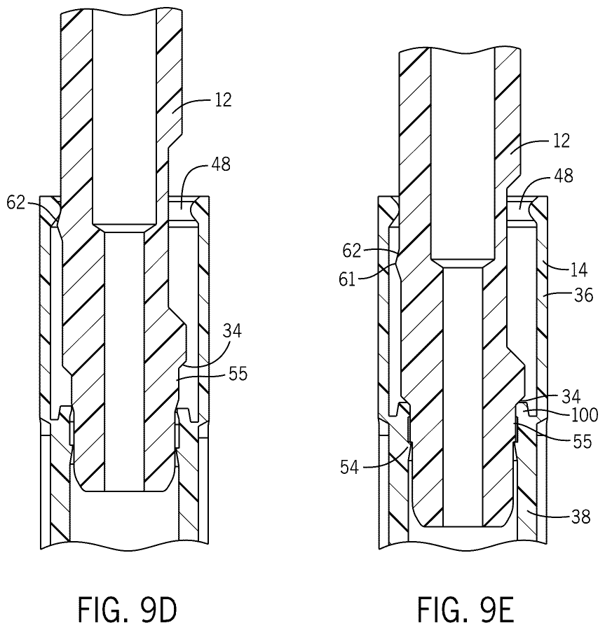

The circumferential shoulder 40 as shown in FIG. 5 is continuous around the circumference of the tip 14. The shoulder 40 is shown to be angular in cross section, however, it need not be angular. The circumferential shoulder 40 provides structural integrity that serves to separate and isolate the distortion of the collar 36 from circular cantilever sealing ring 100. The collar 36 is distorted out-of-round when the mounting shaft 12 is inserted into the pipette tip 14, although as depicted in FIG. 9E the collar 36 is in a relaxed state when the mounting shaft 12 is fully inserted. The circumferential shoulder 40 of the tip 14 isolates the circular cantilever sealing ring 100 from any distortion, thereby facilitating an effective lateral seal between the inside surface 104 of the annular wall 101 of the circular cantilever sealing ring 100 on pipette tip 14 and sealing region 55 on the mounting shaft, see incorporated '304 and '832 applications.

Referring again to FIG. 5, to accurately locate the mounting height of the tip 14 on the mounting shaft 12 when the tip 14 is fully mounted to the mounting shaft 12, the stop 34 on the mounting shaft 12 engages the top edge 102 of the annular wall 101 of the circular cantilever sealing ring 100. With multi-channel devices, this configuration ensures the same vertical mounting distance from tip to tip, which facilitates precise and consistent tip positioning during pipetting. When the tip 14 is in a relaxed state, the inside circumferential surface 104 of the annular wall 101 angles slightly inward as the annular wall 100 extends upward towards the collar opening 42. The slight inward slant provides a lateral interference fit between the inside surface 104 of the annular wall 101 and the cylindrical sealing region 55 of the mounting shaft 12 when the mounting shaft 12 is fully inserted. The annular wall 101 extends upward above the circumferential shoulder 40 such that there is a gap 106 between the annular wall 101 and the collar sidewall 36. The gap 106 enables the annular wall 100 to pivot outward laterally when the pipette mounting shaft 12 is inserted into the tip 14. The inside diameter of the tip immediately below the annular wall 101 is selected to have zero interference with the mounting shaft 14. Rather, the lateral interference fit of the annular wall 101 of the circular cantilever sealing ring 100 above the shoulder 40 of the tip 14 provides the sealing engagement of the tip 14 to the mounting shaft 12.

Referring to FIG. 6, the locking section 30 of the mounting shaft 12 has a central cylindrical aligning section 56 located immediately above and adjacent the stop 34. When the pipette tip 14 is mounted on the mounting shaft 12, the central cylindrical aligning section 56 on the mounting shaft 12 helps to maintain the tip 14 in a straight orientation, however there is preferably clearance between the collar sidewall 36 of tip 14 and central cylindrical aligning section 56 when the tip 14 is mounted on the mounting shaft 12. The diameter of the mounting shaft 12 decreases (e.g., steps down) at the stop 34 between the cylindrical section 56 above the stop 34 and the sealing section 55 below the stop 34. The reduction in shaft diameter at the stop 34 is generally commensurate with the reduction in diameter of the matching pipette tip 14 at its circumferential shelf 40. This reduction is preferably in the range of about 0.1 to 1.0 mm. It is not necessary that the cylindrical aligning section 56 and the stop 34 be continuous around the circumference of the mounting shaft 12 inasmuch as the purpose of these components is to provide secure, stable locking engagement of the pipette tip 14 on the mounting shaft 12 and not to provide a seal. In this regard, the configuration of the mounting shaft 12 is similar to that disclosed in the following above incorporated U.S. Pat. Nos. 7,662,343; 7,662,344; 8,277,757; 8,501,118; 8,877,513 and 9,333,500, which are owned by the assignee of the present application.

Above the cylindrical aligning section 56, the diameter of the mounting shaft 12 may reduce to provide additional clearance between the mounting shaft 12 and the collar of the pipette tip 14. Referring to FIG. 6, as mentioned, the top of the locking section 30 of the mounting shaft 12 includes two or more locking lobes 50 (preferably three) circumferentially spaced evenly around the mounting shaft 12, as well as corresponding recessed areas 58 spanning between the locking lobes 50. The lobes 50 include relatively gently sloping inclining ramps 60. The preferred slope of the inclining ramp 60 with respect to the vertical axis of the mounting shaft is between 10° and 20°. The lobes 50 angle outward as the inclining ramp 60 extends towards a peak portion 61 of the lobe 50. Each lobe 50 also includes a declining ramp 62 which slopes inward as the declining ramp 62 extends upward away from the peak portion 61. Preferably, the inward slope of the declining ramp 62 is the same as the outward slope of the inclining ramp 60, although such symmetry is not necessary. The peak portion 61 is preferably curved and has a radius of between 0.15 and 0.38 mm. At the peak portion 61, the lobes 50 preferably extend outward beyond the outer surface of the cylindrical aligning section 56, although the exact preferred dimensions will depend on the amount of taper of the collar 36 in the corresponding matching pipette tip as well as the tip wall thickness. It is preferred that the mounting shaft 12 be made of a material to reduce rough edges and reduce friction.

The recessed portions 58 between the lobes 50 should consume a substantial portion of the circumference of the mounting shaft 12 both at the peak portion 61 and along the declining ramp 62 where the locking ring 48 on the pipette tip 14 would normally engage when the mounting shaft 12 is fully inserted into the pipette tip 14. Desirably, the lobes 50 at the peak portions 61 consume less than 15% of the mounting shaft circumference. The narrow locking lobes 50 reduce friction associated with mounting and ejecting pipette tips 14. Note that the recesses 58 extend downward along the mounting shaft 12 below the height of the lobes 50 to accommodate inward distortion of the tip collar 36 when the tip is mounted to the mounting shaft 12.

In the incorporated, co-pending '304 and '382 applications, the mounting shaft 12 and the pipette tip 14 are configured so that, during the insertion of the mounting shaft into the pipette tip, the sealing region 55 of the mounting shaft 12 engages the lateral seal 100 on the pipette tip 14 when the lobes 50 on the mounting shaft engage the locking ring 48 on the pipette tip 14. As the mounting shaft continues into the pipette tip, the sealing region of the mounting shaft continues to press laterally against the lateral seal while the lobes on the mounting shaft pass over the locking ring in the collar until the stop on the mounting shaft engages the top of the seal at the circumferential shelf on the tip to stop the downward motion. In accordance with the present invention, the inventors have discovered that offsetting the engagement of the locking ring 48 and the initial engagement of the seal 100 significantly reduces the peak insertion force. This offset can be accomplished by changing the dimensions of the mounting shaft 12 or the dimensions of the pipette tip 14, or both. In the exemplary embodiments of the invention, the distance between locking ring 48 on the collar 36 of the pipette tip 14 and the seal 100 at the circumferential shelf 40 of the pipette tip 14 is greater than the distance between the peak 61 of the locking lobes 50 and the sealing section 55 of the mounting shaft 12.

Accordingly, in the first embodiment of the invention, the peak 61 of the lobes 50 on the mounting shaft 12 pass over the locking ring 48 on the tip collar 14 prior to the sealing region 55 of the mounting shaft 12 engaging the reverse cup seal 100 on the pipette tip 14. When implementing the invention, it is preferred that the mounting shaft be modified to bring the lobes and the sealing region on the mounting shaft relatively closer than shown in the incorporated, co-pending '304 and '382 applications. Without any other modifications, the pipette tips can be effectively mounted on both mounting shafts configured in accordance with the present invention and mounting shafts dimensioned described in the incorporated, co-pending '304 and '382 applications. However, the overall peak insertion force is significantly less if the mounting shaft 12 is dimensioned in accordance with the invention.

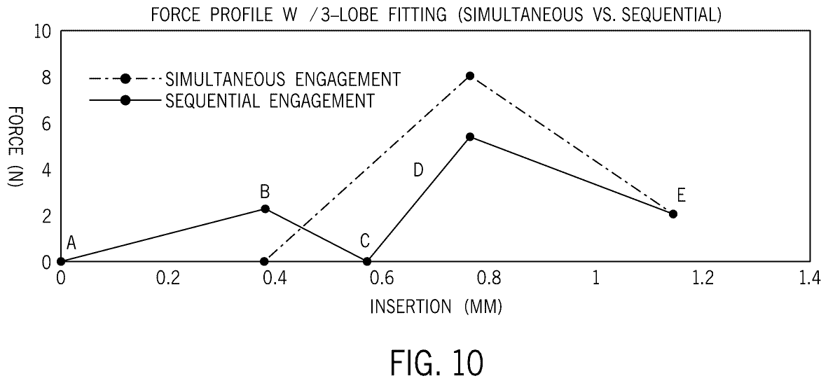

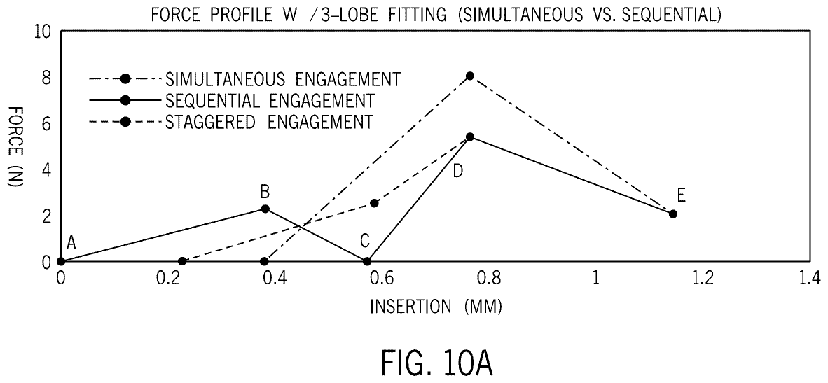

FIGS. 9A through 9E illustrate stages of the insertion of the mounting shaft 12 into the pipette tip 14. FIG. 10 is a plot comparing the required insertion force profile of the mounting shaft 12 and tip configuration 14 illustrated in FIGS. 9A through 9E with sequential engagement to a similarly configured mounting shaft and tip with simultaneous engagement (as described in the incorporated, co-pending '304 and '382 applications).

FIG. 9 A is a drawing showing a mounting shaft 12 and pipette tip 14 configured in accordance with the first embodiment of the invention with the mounting shaft 12 starting to be inserted into the pipette tip 14. The locking lobes 50 on the mounting shaft 12 have just started to contact a locking ring 48 on the inside surface of the tip collar 36. More particularly, the inclined ramp 60 of the lobes 50 on the mounting shaft 12 are starting to engage the locking ring 48 on the tip collar 36 and are starting to distort it out of round as insertion proceeds further. The sealing region 55 on the mounting shaft 12 has not contacted the cantilevered circular seal 100 on the pipette tip in FIG. 9A. The lower region 57 on the mounting shaft 12 below the sealing region 55 is tapered or has a smaller diameter so that it does not engage the cantilevered circular seal 100 on the pipette tip 14 as it passes. It may touch the seal 100 loosely but it does not engage the seal 100 to create a sealing engagement and does require additional insertion force. The lower stabilizing ring 54 in the barrel of the tip 14 maintains alignment of the tip 14 against the lower region 57 of the mounting shaft 12, but again a seal is not formed between the lower stabilizing ring 57 and the lower region 57 of the mounting shaft 12. Referring to FIG. 10, insertion force is plotted against insertion distance in millimeters. The distance 0.0 in FIG. 10 represents the position that the locking ring 48 on the pipette tip is first engaged by the inclined slope 60 of the three locking lobes 50 on the mounting shaft 12. Point A in FIG. 10 corresponds to the relative insertion of the mounting shaft 12 into the tip collar 36 just prior to that shown in FIG. 9A, i.e., insertion is about to begin but no force has been required yet.

FIG. 9B is a view similar to FIG. 9A in which the mounting shaft 12 has been inserted deeper into the pipette tip 14 such that the peak 61 of the lobes 60 on the mounting shaft 12 are passing over the locking ring 48 on the tip collar 36 but the mounting shaft 12 has not yet engaged the cantilevered circular seal 100 on the tip 14. Point B in FIG. 10 corresponds to the relative insertion of the mounting shaft 12 into the tip collar 36 shown in FIG. 9B. Since the collar 36 of the pipette tip 14 is distorted out of round, instead of stretching, the peak insertion force as the peak 61 of the lobes 50 pass over the center of the locking ring 48 is shown in FIG. 10 to be only 2N at a depth of about 0.38 mm (for the tested size of pipette tip). The resiliency of the collar 36 distorted out-of-round stores energy as it is distorted out-of-round, and the maximum amount of stored energy during the shaft insertion is when the peak 60 of the lobes 50 passes over the center of the locking ring 48, i.e. Point B in FIG. 10.

FIG. 9C shows the mounting shaft 12 inserted deeper into the pipette tip 36 such that the peak 61 of the lobes 50 on the mounting shaft 12 have passed over the center of the locking ring 48 on the tip collar 36. The required insertion force lessens and can even become non-existent or negative as resiliency of the distorted collar pushes inward against the declining ramps 62 on the mounting shaft lobes 50. In FIG. 9C, the sealing region 55 on the mounting shaft 12 has still not contacted the seal 100 on the pipette tip 36. Point C in FIG. 10 corresponds to the relative insertion of the mounting shaft 12 into the tip collar 36 shown in FIG. 9C. FIG. 10 shows an insertion depth of slightly less than 0.6, about 5.7 mm for point C, and a required insertion force of 0.0 N at that point of the shaft insertion.

FIG. 9D shows the mounting shaft 12 at an insertion depth such that the sealing region 55 on the mounting shaft 15 is contacting the cantilevered circular seal 100 on the pipette tip 14. Region D in FIG. 10 corresponds to the relative insertion of the mounting shaft 12 into the tip collar 36 shown in FIG. 9D. The data in FIG. 10 shows that the insertion force increases, due to the seal being increasingly engaged, as the mounting shaft 12 is inserted to a depth of about 0.76 mm. The increasing required insertion force along region D represents the sealing region 55 on the mounting shaft 12 engaging deeper into the seal 100 on the pipette tip 14.

FIG. 9E shows the mounting shaft 12 inserted to the full depth such that the stop 34 on the mounting shaft 12 abuts the apex of the seal 100 on the pipette tip 14. Point E in FIG. 10 corresponds to the relative insertion of the mounting shaft 12 into the tip collar 36 shown in FIG. 9E, namely fully mounted. About 2N of force is require to continue moving the mounting shaft 12 into the tip 14 as the fully mounted position is approached, see FIG. 10. FIG. 10 indicates that the insertion force peaks at about 5.7 N as the mounting shaft 12 is being mounted into the tip 14 in this embodiment with offset locking engagement and sealing engagement. The overall insertion distance in the sequential engagement configuration (for the exemplary size of pipette tip) from first contact to full stop is about 1.15 mm in FIG. 10. It is noted that FIG. 9E shows the locking ring 48 on the tip collar 36 to have completely cleared the declining ramp 62 of the lobes on the mounting shaft 12. As depicted in FIG. 9E, the locking ring 48 on the tip collar 36 serves as an upper stabilizing ring 48 when the tip 14 is fully mounted. The collar 36 is fully relaxed and not distorted in FIG. 9E. Specifically, the radius of the mounting shaft 12 above the declining ramps 62 of the locking lobes 60 is selected to match the inside radius of the locking (and upper stabilizing) ring 48 in its relaxed state, or slightly larger (e.g., 1-2 mil) if a higher level of stabilization is desired. By stabilizing with the locking and upper stabilizing ring 48 in the collar 36 and the lower stabilizing ring 54 in the barrel 38, lateral loads on the seal 100 are minimized or eliminated, which improves seal performance under normal working conditions. The presence of upper and lower stabilization rings 48, 55 results in reliable stability and alignment without increasing the required peak insertion force. For smaller sized pipette tips, it has been found preferrable to match the diameters of the upper and lower stabilizing rings with the diameter of the mounting shaft at the respective locations. For longer pipette tips, it may be desirable to provide a slight interference fit particularly with the upper stabilizing ring 48 and the mounting shaft 12. The cross section of the mounting shaft 12 immediately above the lobes 50 is generally triangular (see FIG. 3) with rounded corners. If slight interference is employed, the collar 36 will remain distorted slightly when the tip is fully mounted, however the structural integrity of the circumferential shoulder on the tip isolates the circular and undistorted shape of the base of the circular cantilever sealing ring 100 on the tip 14.

The dashed line in FIG. 10 illustrates a similarly configured pipette tip and mounting shaft, but without offsetting the locking engagement and the sealing engagement (i.e. as shown in incorporated, co-pending '304 and '832 applications). Assuming that the dimensions of the pipette tip are otherwise the same, this means that the distance between sealing ring 100 and the locking ring 48 is less than a configuration designed for sequential engagement in accordance with the invention. The overall insertion distance in the simultaneous engagement case from first contact is about 0.8 mm in FIG. 10. For simultaneous engagement in FIG. 10, first contact occurs at 0.38 mm for both the locking ring 48 and the seal 100 on the pipette tip 14. The required insertion force peaks at about 8 N in FIG. 10 for the simultaneous engagement. The higher peak insertion force is required since the mounting shaft 12 needs to push the lobes 50 through the locking ring 48 in the tip collar 36 at the same time the sealing region 55 on the mounting shaft 12 is engaging the seal 100 on the pipette tip 14.

Testing has shown that offsetting the engagement of the locking ring and the seal has reduced the peak insertion force by about 32% with an uncoated, 3-lobe steel mounting shaft. Using PTFE coated steel or a plastic will reduce the peak insertion force even more, e.g. about a 40% total reduction. The reduction in the peak insertion force is ergonomically helpful for handheld pipettes, especially multi-channel handheld pipettes, and the use of the lobes and locking ring continues to provide over-center tactile feedback and a hard stop even though a lower insertion force is required. In fact, offsetting the locking and sealing functions also results is robust tactile and acoustic feedback that full mounting has been achieved and helps to prevent over exertion particularly in handheld applications. The reduction in the peak insertion force is also useful in automated systems that mount arrays of pipettes tips simultaneously, e.g. 96 or 384 channel heads are the most common. For example, reducing the peak insertion force by 2 N on 384 tips reduces the cumulative required force 768 N. While the reduction in insertion force reduces the requirements and workload of robotic motors, it also enables the use of less robust tip racks.

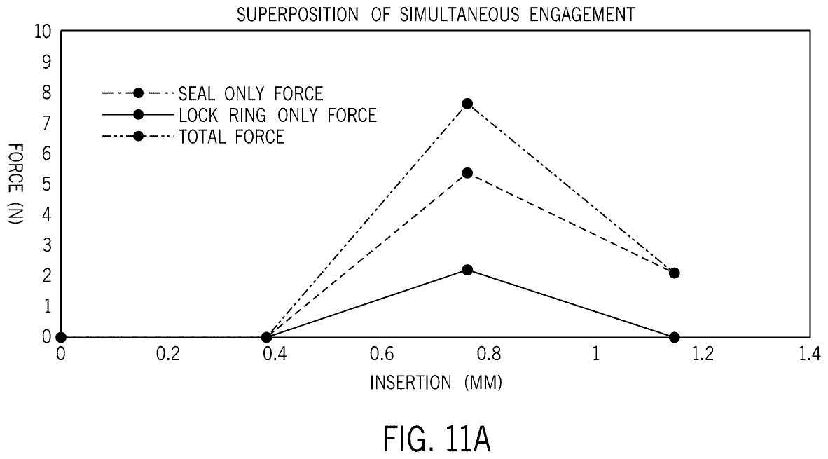

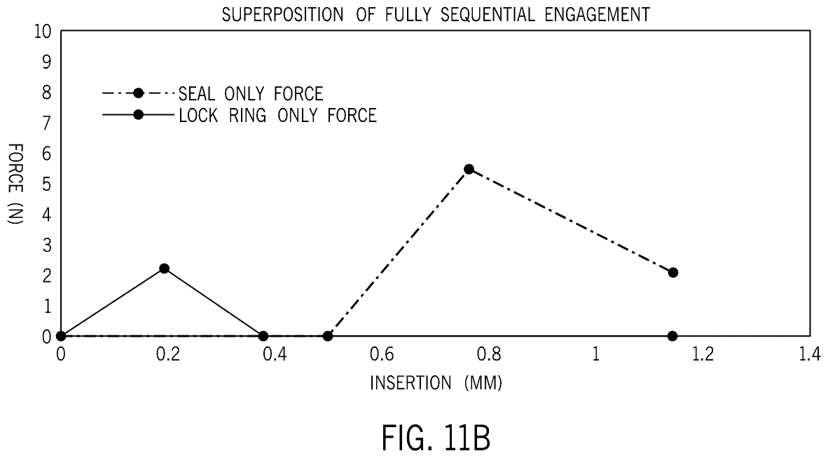

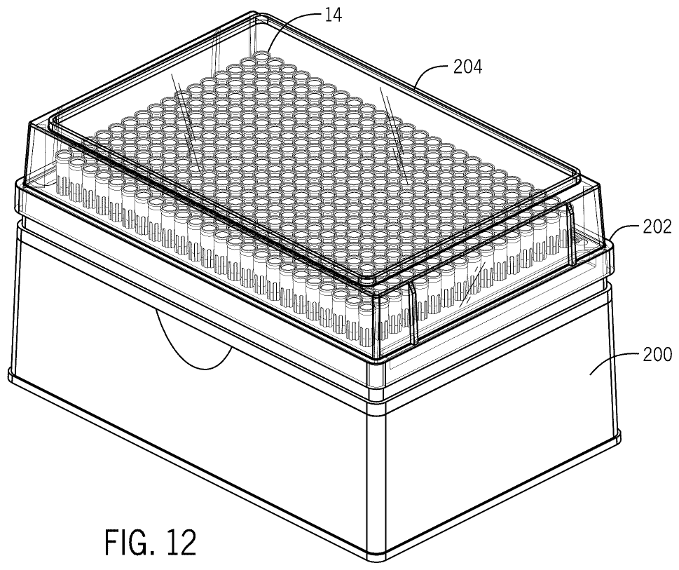

FIG. 11A is a plot illustrating insertion force versus insertion depth with the mounting shaft and pipette tip configured for simultaneous engagement, similar to the prior configurations shown in incorporated '304 and '382 application. FIG. 11B is a plot illustrating insertion force versus insertion depth with the mounting shaft and pipette tip configured for fully sequential engagement, in accordance with one embodiment of the invention. In FIG. 11B, there is about 1 mm of insertion between the completion of the locking function and the engagement of the seal. FIG. 10 showed no additional spacing. It is also contemplated that the locking and sealing function can also overlap to a certain extent without increasing the peak insertion force above that required for the seal only. This is shown in FIG. 10A by the line labelled staggered engagement. It can be seen from FIG. 10A, the staggered engagement if selected properly reduces peak insertion force the roughly the same amount as complete sequential engagement. As mentioned, once the locking ring 48 clears the peak 61 of the lobes 50, the energy in the distorted tip collar 36 releases to assist in mounting the tip. A double click is possible when mounting tips on a handheld pipette with the fully sequential engagement in FIG. 11B or FIG. 10. An advantage of the stop 34 on the mounting shaft 12 is that tactile feedback is provided to the user when the stop 34 engages and abuts the tip seal 100, letting the user know that the tip 14 is fully mounted and there is no need to push the mounting shaft 12 any further. In FIG. 11B or FIG. 10, there is also tactile feedback when the lobes 50 on the mounting shaft 12 clear the peaks 61 of the lobes 60 on locking ring 48. The result is a double click which may or may not be noticeable. However, implementation of overlapping sequential engagement like in FIG. 10A has been found to eliminate any noticeable double click.

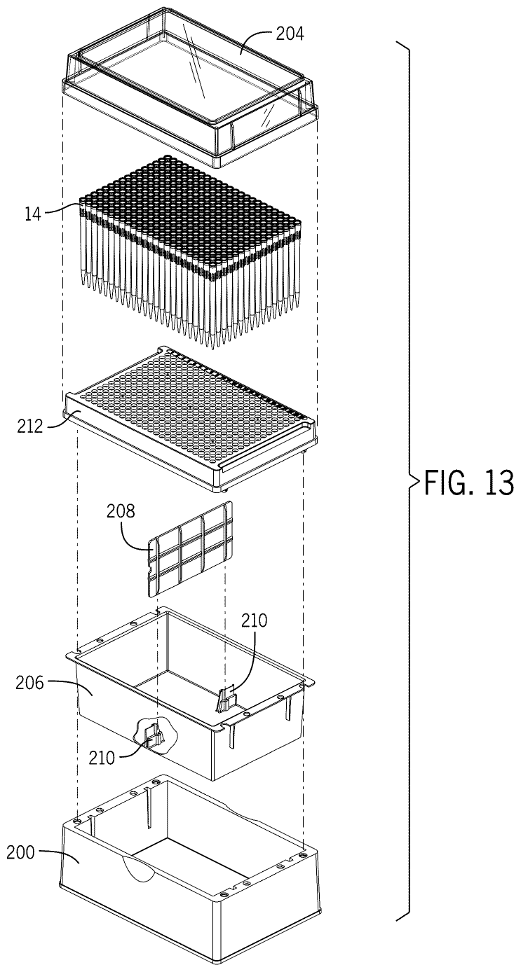

As mentioned, the reduction in insertion forces enables tip racks holding arrays of pipette tips for use in automated or semi-automated liquid handling systems to be made of less plastic. FIG. 12 shows a pipette tip rack system that includes a reusable base 200 and a refill pack 202 containing an array of 384 pipette tips 14 which are configured in accordance with the invention to require reduced insertion force for mounting. In FIG. 12, the refill pack 202 is set in the reusable base 200 with the transparent cover 204 still on. FIG. 13 is an assembly view illustrating components of the refill pack 202, including a disposable tip receptacle 206, a removable vertical support rib 208, a plastic tip insert 212, an array of 384 pipette tips 14 and a transparent cover 204. FIG. 13 also shows the reusable base 200. It is preferred that the outside dimensions of the foot of the reusable base 200 have a dimension consistent with SBS industry standards.

The disposable tip receptacle 206 defines a well for storing the barrel portions of the pipette tips 14 and has two vertical rib mounts 210 that hold the vertical support rib 208 upright so that it supports the plastic tip insert 212. The support by the vertical support rib 208 is provided to keep the plastic tip insert 212 on plane when mounting the array of 384 tips 14 simultaneously to an array of mounting shafts on a pipetting head. The plastic tip insert 212 spans over the well in the disposable tip receptacle 206. The peripheral skirt of the plastic tip insert 212 is supported by the sidewalls of the disposable tip receptacle 206 for packaging purposes. The array of 384 holes in the plastic tip insert 212 holds the array of pipette tips 14 with the centerline of the respective holes spaced apart from one another at a spacing of 4.5 mm in accordance with SBS industry standards. The pipette tips 14 are held substantially vertically with collars of the respective pipette tips facing upward to facilitate mounting of the pipette tips onto an array of pipette mounting shafts 12 on a robotic liquid handling system, e.g. the system 10, although the tips 14 could be used on a handheld pipette too. The transparent cover 204 covers the plastic tip insert 212 and the collars of pipette tips 14 held in place by the plastic tip insert 212 for packaging, shipping and storage purposes. The use of the cover 204 in combination with the disposable tip receptacle 206 and plastic tip insert 212 is effective and convenient to use as packaging for sterile pipette tips but can be used for non-sterile pipette tips as well.

After the tips 14 are mounted, the plastic tip insert 212 can be removed from the disposable tip receptacle 206, and the vertical support rib 208 can also be removable from the vertical rib mounts 210 in the disposable tip receptacle 206. The plastic tip inserts 212 are configured to be stackable and the disposable tip receptacles 206 are configured to be nestable, thereby reducing waste storage needs in the laboratory.

The refill pack 202 shown in FIGS. 12 and 13 holds an array of 384 pipette tips but it should be understood that the tip insert 212 can be modified to hold an array of 96 pipettes tip or more or less pipette tips if desired. Also, in some cases, it may be necessary to include two (or three) removable support ribs 208 to properly support the tip insert 212 when the tips are simultaneously mounted.

A second exemplary embodiment of the invention applies the engagement offset to the mounting of a pipette tip configured to seal in the upper portion of the barrel as in the incorporated U.S. Pat. Nos. 7,662,343; 7,662,344; 8,277,757; 8,501,118; 8,877,513; and 9,333,500. In this embodiment, the pipette tip seals against the mounting shaft below a circumferential shoulder of the tip between the collar and barrel of tip, i.e., the seal occurs in the upper portion of the tip barrel. As described in Applicant's incorporated co-pending application Nos. '304 and '832, the insertion force for sealing in the barrel is greater than the insertion force required for the cup seal. Still, offsetting the initial engagement of the seal with the mounting shaft to occur after the peak of the lobes pass the center of the locking ring on the collar of the pipette tip reduces overall peak insertion force in this second embodiment as well.

While the invention is described in connection with two embodiments, the technique of offsetting the initial engagement of the seal with the mounting shaft from the initial engagement of the locking features on the tip with mounting shaft is useful to reduce insertion force in other embodiments as well.

In more general terms, one aspect of the invention can be described as a pipette system having a tip mounting shaft including locking means (e.g., lobes, stop) for securing the collar of a disposable pipette tip to the mounting shaft when the disposable pipette tip is mounted on the tip mounting shaft, and shaft sealing means for sealing against the mounted pipette tip (sealing region on mounting shaft). The pipette system also has a disposable pipette tip having a barrel with a lower opening through which liquid is aspirated into the barrel and dispensed from the barrel. The collar mounts to the tip mounting shaft and has locking engagement means for engaging said locking means on the mounting shaft (e.g. a locking ring). The disposable pipette tip also has tip sealing means for sealing against said shaft sealing means on the mounting shaft (e.g. a reverse cup seal, or a seal in the barrel of the tip). In accordance with the invention, when the tip mounting shaft is being inserted into the tip collar, the locking engagement means on the tip initially engages the locking means on the mounting shaft prior to the tip sealing means engaging the shaft sealing means.

Desirably, the disposable pipette tip has a stabilization means (e.g. a lower stabilizing ring in the barrel, and the locking ring serving as an upper stabilizing ring) to stabilize the alignment of the disposable pipette tip when it is mounted on the tip mounting shaft. The mounting shaft desirably has three lobes. Each lobe includes a peak portion that is located at a maximum outward distance from a longitudinal axis of the mounting shaft, an inclining ramp portion that slopes outward as the inclining ramp extends upward along the mounting shaft towards the peak portion in order to facilitate distortion of the pipette tip collar as the mounting shaft is inserted into the pipette tip, and a declining ramp portion that slopes inward as the declining ramp extends upward along the mounting shaft away from the peak. The resiliency of the distorted collar stores energy as the peak portion of the lobes passes over the locking ring on the tip collar, and some of the stored energy is released as the declining ramp portion passes over the locking ring during the insertion process. It is preferred that the lobes on the mounting shaft, including the declining ramp portion, fully clear the locking ring when the tip is fully mounted. However, engaging the seal while the locking ring is still engaged with the declining ramp portion should also reduce peak insertion force especially if the peak occurs after the locking ring has cleared the declining ramp prior to that point in the process.

1. A disposable pipette tip for use with a pipette system having a tip mounting shaft that includes an upper locking section having a stop, multiple outwardly extending lobes located above the stop and spaced circumferentially around the locking section of the mounting shaft with recessed relief portion between the lobes, and a sealing area located below the stop, wherein each respective lobe has a peak being spaced longitudinally above the stop on the mounting shaft by a first predetermined distance, said disposable pipette tip comprising:
a barrel having a lower opening through which liquid is aspirated into the barrel and dispensed from the barrel, wherein the diameter of the lower opening is less than the diameter of the barrel at an upper end of the barrel;
a collar having a continuous inner surface with a circular circumference in its relaxed state, an upper opening for receiving the tip mounting shaft, and a lower end with an inside diameter that is larger than an inside diameter of the upper end of the barrel;
a circumferential tip shoulder connecting the lower end of the collar to the upper end of the barrel;
a locking ring extending inward from the continuous inner surface of the collar to engage the locking lobes when mounting the pipette tip to the mounting shaft, said locking ring extending around the entire circumference of the collar or substantially around the entire circumference of the collar and located at a rim of the upper opening of the collar and above the circumferential shoulder at a second predetermined distance that is greater than said first predetermined distance;
a circular cantilever sealing ring having an annular wall extending from the tip shoulder towards the collar opening for laterally engaging and sealing against the sealing area of the mounting shaft when the tip is fully mounted to the mounting shaft; and
said annular wall having a having a top edge that abuts the stop on the pipette mounting shaft when the tip is fully mounted to the mounting shaft;
wherein the collar of the disposable pipette tip is sufficiently flexible to distort outwardly at the lobes on the mounting shaft and inwardly at recessed relief portions on the mounting shaft between the lobes when the pipette tip is being mounted on to the tip mounting shaft, and wherein the circumferential shoulder has sufficient structural integrity to maintain adequate roundness of the circular cantilever sealing ring so that the annular wall seals laterally against the sealing area of the mounting shaft; and further when the disposable pipette tip is being mounted on the tip mounting shaft, the locking ring in the collar of the disposable pipette tip engages the locking lobes on the tip mounting shaft prior to the a circular cantilever sealing ring engaging and sealing against the sealing area of the mounting shaft.

2. The disposable pipette tip as recited in claim 1 wherein an inside surface of the annular wall slants inward in its relaxed state as it extends from the circumferential shoulder toward the opening in the collar.

3. The disposable pipette tip as recited in claim 1 wherein an inside surface of the annular wall forms an interference of 0.05 to 0.11 mm with a cylindrical sealing region on said mounting shaft.

4. The disposable pipette tip as recited in claim 1 wherein the slant of the inside surface continues as the surface extends downward to a threshold location for zero interference location and beyond the threshold location to provide ample clearance between the inside surface of the pipette tip and the mounting shaft below the threshold location.

5. The disposable pipette tip as recited in claim 1 further comprising a lower stabilizing ring located in an upper portion of the tip barrel which extends inward from the inside surface of the barrel.

6. The disposable pipette tip as recited in claim 1 wherein the circular cantilever sealing ring on the pipette tip further comprises a circumferential gap above the circumferential shoulder between the annular wall of the circular cantilever sealing ring and the tip collar.

7. The disposable pipette tip as recited in claim 1 wherein the circumferential locking ring on the tip includes a void.

8. The disposable pipette tip as recited in claim 1 wherein the pipette tip is made of molded polypropylene.

9. The disposable pipette tip as recited in claim 1 wherein the second distance is sufficiently larger than the first distance such that the locking ring in the collar of the disposable pipette tip fully clears the locking lobes on the mounting shaft with the collar in a relaxed state when the disposable pipette tip is fully mounted to the mounting shaft and the top edge of the annular wall of the circular cantilever sealing ring on the pipette tip abuts the stop on the mounting shaft; and further wherein an inside radius of the locking ring in the collar is essentially the same as the radius of the mounting shaft above lobes such that the locking ring serves as an upper stabilizing ring when the tip is fully mounted.

10. The disposable pipette tip as recited in claim 1 wherein the second distance is sufficiently larger than the first distance such that the locking ring in the collar of the disposable pipette tip fully clears the locking lobes on the mounting shaft with the collar in a relaxed state when the disposable pipette tip is fully mounted to the mounting shaft and the top edge of the annular wall of the circular cantilever sealing ring on the pipette tip abuts the stop on the mounting shaft; and further wherein an inside radius of the locking ring in the collar is slightly smaller than the radius of the mounting shaft above lobes such that the locking ring is distorted slightly out of round and serves as an upper stabilizing ring when the tip is fully mounted.

11. A refill pack containing an array of disposable pipette tips, each configured as recited in claim 1.

12. The refill pack containing an array of disposable pipette tips recited in claim 11, wherein the refill pack comprises:
a tip receptacle with a bottom wall, lateral sidewalls, a front sidewall and a back sidewall, wherein the tip receptacle defines a well for storing the barrel portions of pipette tips and has one or more vertical rib mounts;
a plastic tip insert spanning over the well and having a peripheral skirt supported by the sidewalls of the tip receptacle for packaging purposes, the plastic tip insert having an array of holes for holding an array of pipette tips with the centerline of the respective holes spaced apart from one another at a spacing of 4.5 mm or 9 mm, such that the pipette tips are held substantially vertically with collars of the respective pipette tips facing upward to facilitate mounting of the pipette tips onto an array of pipette mounting shafts on a robotic liquid handling system, said plastic tip insert being removably attached to the tip receptacle;
a removable cover that covers the plastic tip insert and the collars of pipette tips held in place by the plastic tip insert; and
a vertical support rib that is set in the one or more vertical rib mounts and extends upward from the bottom wall of the tip receptacle to a bottom surface of the plastic tip insert, said vertical support rib being removable from the one or more vertical rib mounts and from the tip receptacle; and
an array of 96 or 384 disposable pipette tips contained in the plastic tip insert.

13. A pipette system comprising at least one tip mounting shafts and a disposable pipette tip as recited in claim 1.

14. A pipette system comprising a nest for holding a base for a tip refill pack, and a refill containing an array of disposable pipette tips as recited in claim 11.

15. A pipette system comprising:
a tip mounting shaft including locking means for securing the collar of a disposable pipette tip to the mounting shaft when the disposable pipette tip is mounted on the tip mounting shaft and shaft sealing means for sealing against the mounted pipette tip; and
disposable pipette tip having a barrel with a lower opening through which liquid is aspirated into the barrel and dispensed from the barrel, a collar that mounts to the tip mounting shaft, said collar having lock engagement means for engaging said locking means on the mounting shaft, and said disposable pipette tip also having tip sealing means for sealing against said shaft sealing means;
wherein the tip mounting shaft is inserted into the collar of the disposable pipette tip to mount the disposable pipette tip to the tip mounting shaft, and when the tip mounting shaft is being inserted the lock engagement means on the tip engages the locking means prior to the tip sealing means engaging the shaft sealing means.

16. The pipette system in claim 15 wherein the disposable pipette tip further comprises stabilization means to stabilize the alignment of the disposable pipette tip when it is mounted on the tip mounting shaft.

17. The pipette system in claim 15 wherein said locking means on the tip mounting shaft for securing the collar of the disposable pipette tip to the mounting shaft comprises multiple outwardly extending lobes circumferentially spaced around the upper locking section of the mounting shaft and located above the stop on the mounting shaft, and recessed relief portions spanning between the lobes and recessed relative to the lobes such that the collar distorts outwardly at the lobes and inwardly at the relief portions when the pipette tip is being mounted on the mounting shaft over the lobes.

18. The pipette system in claim 17 wherein the tip mounting shaft further comprises a stop and said shaft sealing means on the mounting shaft for sealing against the mounted pipette tip is located at least in part below the stop.

19. The pipette system in claim 18 wherein the collar has an upper opening for receiving a pipette tip mounting shaft and said collar locking means comprises a substantially circumferential locking ring extending inward from an inside surface of the collar, which fully clears the outwardly extending lobes on the mounting shaft when the pipette tip is fully mounted on a pipette mounting shaft.

20. The pipette system in claim 19 wherein:
the lower end of the collar has a larger inside diameter than the inside diameter at the upper end of the barrel, and a circumferential shoulder that connects the lower end of the collar to the upper end of the barrel;
said tip sealing means for sealing against said shaft sealing means comprises a circular cantilever sealing ring having an annular wall extending from the tip shoulder towards the collar opening and having an inside surface, a top edge and a corner between the inside surface and the top edge, wherein said inside surface slants inward as it extends upward towards the collar opening;
the stop on the tip mounting shaft engages and abuts annular wall of the circular cantilever sealing ring when the mounting shaft is fully inserted into the collar of the pipette tip; and
said shaft sealing means for sealing against the mounted pipette tip is a sealing region of the tip mounting shaft located below the stop that laterally engages the inside surface of the annular wall of the circular cantilever sealing ring on the pipette tip to seal the mounting shaft against the pipette tip when the mounting shaft is fully inserted into the collar of the pipette tip.

21. The pipetting system recited in claim 19 wherein the circumferential locking ring includes a void.

22. The pipetting system recited in claim 20 wherein the sealing region of the mounting shaft is cylindrical.

23. The pipetting system recited in claim 20 wherein the sealing region of the mounting shaft includes an O-ring.

24. The pipetting system recited in claim 20 wherein the stop on the mounting shaft is angular and the angular stop engages said corner of the annular wall of the circular cantilever sealing ring when the mounting shaft is fully inserted in the pipette tip.

25. A pipette system comprising a tip mounting shaft and a disposable pipette tip, wherein the tip mounting shaft comprises a lower sealing section and an upper locking section, the upper locking section including a stop, two or more outwardly extending lobes spaced circumferentially around the locking section of the mounting shaft and each lobe having a catch surface located above the stop on the mounting shaft by a first predetermined distance, and recessed relief portions spanning circumferentially between the lobes and recessed relative to the lobes, the lower sealing section of the tip mounting shaft having a diameter less than the diameter of a portion of the upper locking section immediately adjacent the stop and having a circular cross-section, and the disposable pipette tip comprises:
a barrel having a lower opening through which liquid is aspirated into the barrel and dispensed from the barrel, an upper end with a circular circumference and an inside diameter, and an upper portion having an inside surface with a circular circumference that serves as a sealing area for the tip against the mounting shaft;
a collar having a continuous inner surface with a circular circumference in its relaxed state, an upper opening for receiving a tip mounting shaft, and a lower end with a circular circumference it its relaxed state and an inside diameter that is larger than the inside diameter of the upper end of the barrel;
a circumferential shelf connecting the lower end of the collar to the upper end of the barrel; and
a locking ring extending inward from the continuous inner surface of the collar and around the entire circumference of the collar or substantially around the entire circumference of the collar and located at a rim of the upper opening of the collar and above the circumferential shelf at a second distance that is more than the first distance between the stop on the mounting shaft and the catch surfaces on the respective locking lobes on the mounting shaft; and
sealing means on the upper portion of the barrel below the circumferential shelf for sealing the pipette tip against the lower sealing section of the tip mounting shaft when the disposable pipette tip is mounted on the tip mounting shaft.

26. The pipette system as recited in claim 25 wherein said sealing means for sealing the pipette tip against the lower section of the tip mounting shaft comprises a circumferential ring encircling the inside surface of the barrel of the pipette tip and extending inward from the inside surface of the barrel.

27. The pipette system as recited in claim 25 wherein said sealing means on the upper portion of the tip barrel for sealing the pipette tip against the lower sealing section of the tip mounting shaft when the disposable pipette tip is mounted on the tip mounting shaft comprises an upper portion of the inside surface of the barrel adapted to engage an O-ring on the tip mounting shaft, and the disposable pipette tip further comprises a circumferential stabilization ring encircling the inside surface of the barrel and extending inward from the inside surface of the barrel.

28. The pipette system as recited in claim 25 wherein the disposable pipette tip further comprises a circumferential stabilization ring encircling the inside surface of the barrel and extending inward from the inside surface of the barrel, said circumferential stabilization ring being located below said sealing means for sealing the disposable pipette tip.
